(19) United States
(12) Patent Application Publication
(10) Pub. No.: US 2015/0100517 A1
(43) Pub. Date: Apr. 9, 2015

(54) Providing a Guarantee Associated with an Investment

(71) Applicants: Srinivas D. Reddy, South Windsor, CT (US); Clinton M. Barker, Summit, NJ (US)

(72) Inventors: Srinivas D. Reddy, South Windsor, CT (US); Clinton M. Barker, Summit, NJ (US)

(21) Appl. No.: 14/046,527

(22) Filed: Oct. 4, 2013

(51) Int. Cl. G06Q 40/06

(52) U.S. Cl. CPC G06Q 40/06
USPC 705/36 R

(57) ABSTRACT

According to one embodiment, a system includes one or more processors operable to receive data indicative of an account associated with one or more investments by an investor in a target date fund. The processors are further operable to calculate a plurality of premium amounts for a plurality of negative guarantees, communicate an indication of the premium amounts and the negative guarantees, and receive an indication of a selection of one of the negative guarantees. The selected negative guarantee provides a guarantee that, at a realization date, an account value of the account will be at least equal to an amount less than a principal amount regardless of market performance of the target date fund. The processors are further operable to, at the realization date, determine whether the selected negative guarantee was met by the account value, and communicate an indication of whether the selected negative guarantee was met.

### TECHNICAL FIELD

This disclosure relates generally to investments and more particularly to providing a guarantee associated with an investment.

### BACKGROUND

There are numerous investment vehicles available on the market and people utilize them for a variety of reasons. Some investors are interested in obtaining high rates of return on their investments, while others are willing to forego high rates of return in exchange for a reduced level of financial risk. The typical investment vehicles, however, may be deficient.

### SUMMARY

According to one embodiment, a system includes a memory and one or more processors communicatively coupled to the memory. The processors are operable to receive data indicative of an account associated with one or more investments by an investor in a target date fund. The target date fund comprises a target date and a portfolio of assets. The target date fund is configured to change the portfolio of assets as the target date approaches. The processors are further operable to calculate a plurality of premium amounts for a plurality of negative guarantees associated with the account. Each of the plurality of premium amounts is associated with a different one of the plurality of negative guarantees. The processors are further operable to communicate for display an indication of the plurality of premium amounts and the associated plurality of negative guarantees. The processors are further operable to receive an indication of a selection of one of the associated plurality of negative guarantees. The selected negative guarantee provides a guarantee to the investor that, at a realization date, an account value of the account will be at least equal to an amount less than a principal amount associated with the one or more investments regardless of market performance of the target date fund. The processors are further operable to, beginning at a predetermined date before the realization date, periodically compare the account value to the selected negative guarantee, and based on the comparison, communicate for display an indication of whether the selected negative guarantee is expected to be met by the account value based on the market performance of the target date fund. The processors are further operable to, at the realization date, determine whether the selected negative guarantee was met by the account value, and, following the determination, communicate for display an indication of whether the selected negative guarantee was met by the account value.

Certain embodiments may provide various technical advantages. For example, an issuer (e.g., a bank, an insurance company, etc.) be able to provide a guarantee associated with a target date fund. As another example, the issuer may also be able to determine, at the realization point, whether or not the guarantee was actually met, and whether or not the issuer may need to pay out on the guarantee. As a further example, the issuer may be able to track whether or not the guarantee is expected to be met by the account value, and may be able to prepare for whether or not the issuer will have to pay out on the guarantee.

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and various advantages, reference is now made to the following description, taken in conjunction with the accompanying drawings, in which:

FIG. 1 illustrates an example system for providing a guarantee associated with a target date fund; and

FIG. 2 illustrates an example method for providing a guarantee associated with a target date fund.

### DETAILED DESCRIPTION OF THE EXAMPLE EMBODIMENTS

It should be understood at the outset that although example implementations of embodiments of the disclosure are illustrated below, the present disclosure may be implemented using any number of techniques, whether currently known or not. The disclosure should in no way be limited to the example implementations, drawings, and techniques illustrated below. Additionally, the drawings are not necessarily drawn to scale.

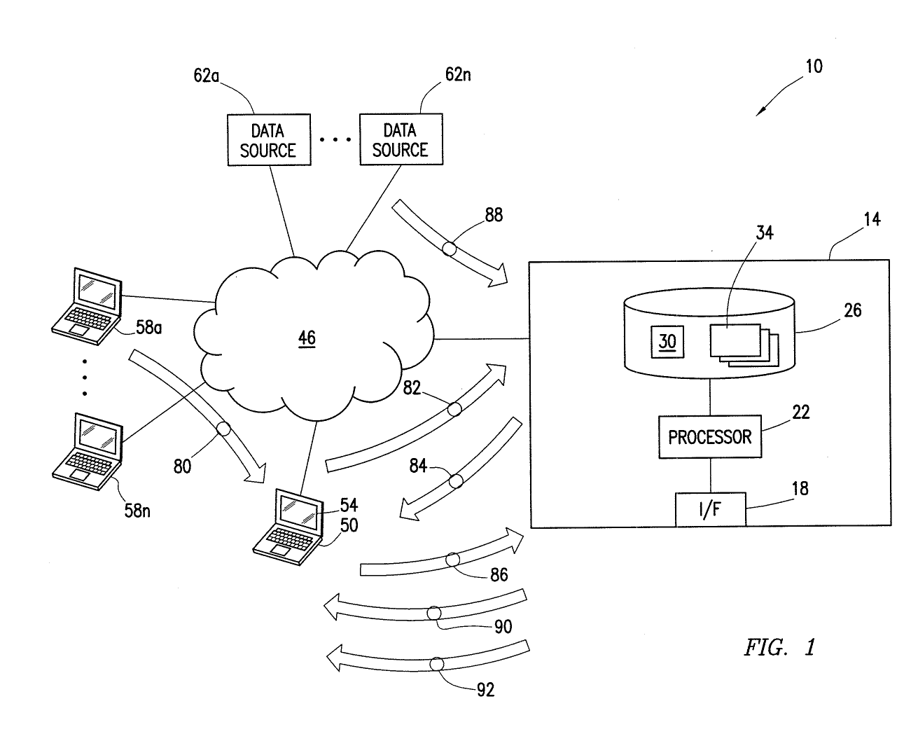

FIG. 1 illustrates a system 10 for providing a guarantee associated with a target date fund (or any other investment). System 10 includes a calculation device 14 that receives data indicative of an account associated with one or more investments by an investor in a target date fund. After receiving the data, calculation device 14 may calculate and communicate one or more premium amounts associated with providing a guarantee for the account. Furthermore, calculation device 14 may receive a selection of a guarantee. Prior to a realization date associated with the selected guarantee, calculation device 14 may compare the account value of the account to the selected guarantee, and communicate for display an indication of whether the selected guarantee is expected to be met by the account value. Furthermore, at the realization date associated with the selected guarantee, calculation device 14 may determine whether the selected guarantee was met by the account value, and communicate for display an indication of whether the selected guarantee was met by the account value. As such, an issuer (e.g., a bank, an insurance company, etc.) may be able to provide a guarantee associated with a target date fund. Furthermore, the issuer may be able to track whether or not the guarantee is expected to be met by the account value. As such, the issuer may be able to prepare for whether or not the issuer will have to pay out on the guarantee. Additionally, the issuer may also be able to determine, at the realization point, whether or not the guarantee was actually met, and whether or not the issuer may need to pay out on the guarantee.

A target date fund may represent an investment vehicle that may change the portfolio of assets in which it is invested over time based on time or date. A target date fund may have a target date and a portfolio of assets in which it is invested. The target date of a target date fund may represent a point in time (time or date) when money invested in the target date fund is expected to be needed (or otherwise used) by an investor. For example, the target date of a retirement-based target date fund may be the point in time when the investor is expected to retire (e.g., 2060, 2070, 2080, etc.). The target date may be any time or date associated with the target date fund. For example, the target date may be a year (e.g., 2060, 2070, 2080, etc.), an amount of time in the future (e.g., 10 years, 20 years, 30 years, 40 years, etc.), any other time or date, or any combination of the preceding. The portfolio of assets in which the target date fund is invested in may include any suitable type of assets. For example, the portfolio may include stocks, bonds, cash, real property, treasuries, private equities, intangible assets, tangible assets, any other suitable type of asset, or any combination of the preceding. Furthermore, the portfolio may include any suitable arrangement (or mix) of the assets. As an example, the portfolio may include, for example, 90% stocks and 10% bonds. As a further example, the portfolio may include, for example, 50% stocks, 40% bonds, and 10% cash.

Although the target date fund may include a portfolio of assets in which it is invested, the target date fund may change the portfolio of assets over time. For example, the target date fund may be a retirement-based target date fund that changes its portfolio assets to be more conservative as the target date associated with the target date fund approaches. As an example of this, the target date fund may be a retirement-based target date fund with a target date of 2060. In the earlier years of the target date fund (e.g., 2015, 2020, 2025, etc.), the portfolio of assets may include a mix of assets that are higher in risk, but also higher in potential rate of return. However, as the target date fund approaches the year 2060 (i.e., the target date), the portfolio of assets may change to a more conservative mix, such as a mix that includes more low risk assets with a lower rate of return. This change to a more conservative investment strategy may assist an investor during retirement because his investments in the target date fund may be more secure (e.g., have a lower level of risk) when the investor is near retirement. As such, there may be less risk of the investor's account losing value near the investor's retirement.

An investor may represent any entity that may invest in a target date fund (or any other investment), such as a person, an organization, a corporation, an investment fund (e.g., an investment fund that includes the target date fund as one of the assets in the portfolio of the fund), any other entity, or any combination of the preceding. The investor may invest in the target date fund (or any other investment) for any suitable reason. For example, an individual person may invest in the target date fund in order to save for retirement. As another example, an investment fund may invest in a target date fund in order to provide a different type of asset in its portfolio and/or to provide a particular rate of return to investors in the fund.

Typically, a target date fund may be utilized by an investor to prepare for retirement. For example, an investor may make one or more investments in the target date fund, and a manager of that target date fund may invest in assets in a manner designed to help the investor prepare for retirement. Unfortunately, although a target date fund may be configured to assist an investor in preparing for retirement (or for any other event associated with a target date), a target date fund is traditionally not associated with a guarantee that may guarantee all or a portion of the investor's investment in the target date fund. Contrary to this, however, system 10 may provide a guarantee (e.g., a positive guarantee, a negative guarantee, etc.) associated with a target date fund. As such, if the guarantee is not met by the account value by a realization date associated with the guarantee, the issuer of the guarantee may pay out to the investor the difference between the guarantee and the account value. For example, if an investor's account value was guaranteed to be worth $100,000 by the year 2060, but is only worth $80,000 by the year 2060, the issuer of the guarantee may pay out the $20,000 difference to the investor.

As is discussed above, system 10 includes calculation device 14. Calculation device 14 may represent any components that provide calculations, determinations, and/or communications associated with a guarantee, and may be implemented using any suitable combination of hardware, firmware, and software. Calculation device 14 may include a network server, any remote server, a mainframe, a host computer, a workstation, a web space server, a personal computer, a file server, or any other device operable to provide calculations, determinations, and/or communications associated with a guarantee. The functions of calculation device 14 may be performed by any combination of one or more servers or other components at one or more locations. If the module is a server, the server may be a private server, and the server may be a virtual or physical server. The server may include one or more servers at the same or remote locations. Also, calculation device 14 may include any component that functions as a server.

Calculation device 14 may be associated with an issuer. An issuer may represent an entity that generates (or otherwise provides) a guarantee associated with a target date fund (or any other investment). For example, the issuer may be a bank, an insurance company, a mutual fund company, any other business entity engaged in the sale, issuance, and/or management of one or more guarantees associated with a target date fund (or any other investment), or any combination of the preceding. The issuer may also represent multiple entities that operate together to provide a guarantee associated with a target date fund. By providing a guarantee associated with a target date fund, if the guarantee is not met by the realization point, the issuer may pay out to the investor the difference between the guarantee and the account value of the investor at the realization point.

As illustrated, calculation device 14 includes a network interface 18, a processor 22, and a memory 26. Network interface 18 may represent any device operable to receive information from network 46, transmit information through network 46, perform processing of information, communicate to other devices, or any combination of the preceding, and may be implemented using any suitable combination of hardware, firmware, and software. For example, network interface 18 may receive information from a data source 62. As another example, network interface 18 may communicate premium amounts for display on a user device 58. Network interface 18 may represent any port or connection, real or virtual, including any suitable hardware and/or software, including protocol conversion and data processing capabilities, to communicate through a local area network (LAN), a metropolitan area network (MAN), a wide area network (WAN), or other communication system that allows calculation device 14 to exchange information with network 46, issuer device 50, user devices 58, data sources 62, or other components of system 10.

Processor 22 communicatively couples to network interface 18 and memory 26, and controls the operation and administration of calculation device 14 by processing information received from network interface 18 and memory 26. For example, processor 22 executes calculation device management application 30 to control the operation of calculation device 14. Processor 22 may be a programmable logic device, a microcontroller, a microprocessor, any processing device, or any combination of the preceding.

Memory 26 stores, either permanently or temporarily, data, operational software, or other information for processor 22. Memory 26 includes any one or a combination of volatile or non-volatile local or remote devices suitable for storing information. For example, memory 26 may include random access memory (RAM), read only memory (ROM), magnetic storage devices, optical storage devices, any other information storage device, or any combination of the preceding. While illustrated as including particular modules, memory 26 may include any information for use in the operation of calculation device 14.

As illustrated, memory 26 includes calculation device management application 30, and guaranteed accounts 34. Calculation device management application 30 may represent any suitable set of instructions, logic, or code embodied in a computer readable storage medium and operable to facilitate the operation of calculation device 14.

Guaranteed accounts 34 represent any information associated with one or more guarantees provided by the issuer. A guaranteed account 34 may include any information that may allow calculation device 14 to determine whether a guarantee is expected to be met by an account value associated with a target date fund, determine whether the guarantee was actually met by the account value at a realization date, conduct any other calculation and/or determination associated with the guarantee, account value, and/or target date fund, or any combination of the preceding. Examples of information included in guaranteed account 34 may include an identifier associated with an investor (e.g., the investor's name, the investor's social security number, the investor's address, the investor's account number, etc.); an identifier associated with a target date fund invested in by the investor (e.g., the name of the target date fund, an acronym associated with the target date fund, an identifier of the manager of the target date fund, the target date of the target date fund, the current portfolio of the target date fund, the risk assessment of the target date fund, etc.); data indicative of an account value of an account of the investor (e.g., the current account value of one or more investments by the investor in the target date fund, the number of shares in the target date fund owned by the investor, the principal amount of the target date fund (e.g., the amount of investments or deposits by the investor in the target date fund), the current price per share of the target date fund, the forecasted (or expected) growth (e.g., positive, negative, neutral) of the target date fund, etc.); data indicative of a guarantee associated with an investor's investment(s) in the target date fund (e.g., the type of guarantee (e.g., a guarantee of the principal amount, a guarantee of the highest value of the account value, a guarantee of a particular portion of the account value, etc.), the amount of the guarantee, the date the guarantee is associated with (i.e., the realization date of the guarantee), the guarantee activation date of the guarantee, etc); any other information associated with the guarantee, any other information associated with the target date fund; any other information associated with the investor or the account of the investor; or any combination of the preceding. Calculation device 14 may receive the information included in guaranteed accounts 34 in any suitable manner. For example, an employee of the issuer (using issuer device 50) or an investor (using user device 58) may provide the information to calculation device 14. As another example, data sources 62 may provide the information to calculation device 14.

Network 46 may represent any network operable to facilitate communication between the components of system 10, such as calculation device 14, issuer device 50, user devices 58, and data sources 62. Network 46 may include any interconnecting system capable of transmitting audio, video, signals, data, messages, or any combination of the preceding. Network 46 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

Issuer device 50 may represent any components that may provide information to calculation device 14 and/or display information received from calculation device 14. For example, an employee of the issuer (or any other person, entity, etc.) may utilize issuer device 50 to provide information associated with the target date fund, the investor, and/or the guarantee to calculation device 14 for storage as guaranteed account 34 for the investor. As another example, issuer device 50 may display (to an employee of the issuer or any other person, entity, etc.) information received from calculation device 14, such as an indication of whether an account value of an investor's account is expected to meet the guarantee by the realization date. Issuer device 50 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to provide information to calculation device and/or display information received from calculation device 14. Issuer device 50 may further allow a user (such as an employee of the issuer) to request information from calculation device 14. Issuer device 50 may comprise a user interface, such as a display, a microphone, keypad, or other appropriate terminal equipment usable by a user.

Issuer device 50 may display a graphical user interface 54 in order to allow a user to view the information provided by calculation device 14. Graphical user interface 54 may include any graphical interface that allows the user to view information provided by calculation device 14, request information from calculation device 14, and/or provide information to calculation device 14. For example, graphical user interface 54 may allow a user of issuer device 50 to view whether a guarantee associated with a target date fund was met by the account value of the investor. As another example, graphical user interface 54 may allow the user to input one or more pieces of information to transmit to calculation device 14 for storage in guarantee account 34. Furthermore, graphical user interface 54 may be accessible to a user through a web browser.

User device 58 may represent any components that may allow a user (such as an investor) to request information from issuer device 50 and/or provide information to issuer device 50. User device 58 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10 in order to allow a user (such as an investor) to request information from issuer device 50 and/or provide information to issuer device 50. For example, user device 58 may be utilized by an investor to request (or otherwise apply for) a guarantee on a target date fund in which the investor is invested in. User device 58 may comprise a user interface, such as a display, a microphone, keypad, or other appropriate terminal equipment usable by a user.

Although FIG. 1 illustrates system 10 as only including two user devices 58 (user device 58a and user device 58n), system 10 may include any suitable number of user devices 58. For example, system 10 may include less than two user devices 58 or more than two user devices 58. Furthermore, although FIG. 1 illustrates user device 58 as communicating with issuer device 50, user device 58 may also communicate directly with calculation device 14. Additionally, although FIG. 1 illustrates system 10 as including user devices 58, a user (such as an investor) may not utilize a user device 58 at all. In such an example, the user may contact the issuer (e.g., by telephone, mail, in-person, any other means of communication, or any combination of the preceding) to request information from the issuer regarding a guarantee and/or to provide information to the issuer regarding a guarantee. As an example, an investor may contact the issuer by phone in order to apply for a guarantee on their investments in a target date fund. In such an example, after the investor has applied for the guarantee over the phone, an employee of the issuer may input the information into calculation device 14.

Data source 62 may represent any source of information that may be used by calculation device 14. Data source 62 may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of a target date fund and who provides such knowledge for communication to a calculation device 14), the Internet (which may include information about one or more assets invested in by the target date fund), one or more devices associated with third parties (such as Moody's Investors Service, Barclays Investment Bank, Standard & Poor's, etc.), any other suitable source of information, or any combination of the preceding. As is illustrated, calculation device 14 may receive information from data sources 62 in order to determine whether or not a guarantee is expected to be met by an account value by a realization date (e.g., based on the market performance of the target date fund), determine whether or not the guarantee was met by the account value by the realization date, perform any other calculations, determinations, and/or communications associated with a guarantee, a target date fund, and/or an account of an investor, or any combination of the preceding.

Although FIG. 1 illustrates system 10 as only including two data sources 62 (data source 62a and data source 62n), system 10 may include any suitable number of data sources 62. For example, system 10 may include less than two data sources 62 or more than two data sources 62. Furthermore, although FIG. 1 illustrates calculation device 14, issuer device 50, user devices 58, and data sources 62 as separate components, two or more of the calculation device 14, issuer device 50, user devices 58, and data sources 62 may be the same component. For example, the calculation device 14 and issuer device 50 may be the same device. As such, a user may view whether or not the guarantee was met at the same device that determines whether the guarantee was met. As another example, data sources 62 may be the same device as issuer device 50. As such, calculation device 14 may receive information from the same device that displays whether or not the guarantee was met.

In an example embodiment of operations, system 10 may provide a guarantee associated with a target date fund. The guarantee may be any guarantee associated with an investor's investment in any target date fund. The guarantee may be a positive guarantee, a negative guarantee, or any other guarantee. For example, the guarantee may be a positive guarantee that provides that the investor is guaranteed to receive a minimum guaranteed rate of return that is greater than 0% (e.g., 1%, 2%, 3%, 5%, 10%, 20%, 30%, 100%, 200%, or any other positive percentage). In such an example, the positive guarantee may guarantee that the investor's investments will increase by a particular rate of return. As another example, the guarantee may be a negative guarantee that provides that the investor is guaranteed to receive at least a rate of return less than 0% (e.g., −1%, −2%, −3%, −5%, −10%, −20%, −30%, or any other negative percentage). In such an example, the negative guarantee may guarantee that the investor's investments will not decrease by more that a particular rate of return. As an example of this, if an investor has a negative guarantee of −25% (i.e., the investor is guaranteed at least 75% of their investment no matter how badly the investment actually performs) and the investor invests $100,000 in the target date fund, the guarantee may provide that the investor's investment of $100,000 will not be worth less than $75,000 at a realization date. As a further example, the guarantee may provide that the investor is guaranteed to receive at least a 0% rate of return. Additionally, the guarantee my provide that the investor is guaranteed to receive any percentage of rate of return within the following ranges: −95% to 100%, −50% to 50%, −25% to 25%, 0% to 100%, −95% to 0%, −25% to −0.01%, −50% to −5%, −50% to −10%, −50% to −15%, or any other range of rate of returns.

The guarantee may provide a guarantee on all or a portion of the account value of the investor in the target date fund. For example, the guarantee may provide a guarantee of principal amount (e.g., the amount of investments or deposits by the investor in the target date fund). In such an example, if the investor invests $100,000 in a target date fund, the guarantee may be based on that $100,000 investment. As another example, the guarantee may provide a guarantee of the highest value of the account value, a guarantee of the account value on a particular date/time (e.g. such as when the guarantee was established), a guarantee of a particular portion of the account value, a guarantee of an amount agreed to by the investor and the issuer, or a guarantee of any other portion of the account value.

The guarantee may be associated with a realization date. The realization date may represent the date the guarantee is due. For example, the guarantee may provide that an account value of the investor in the target date fund will meet (i.e., be equal to or exceed) the guarantee at the realization date. In such an example, if the realization date is the year 2050, the guarantee may provide that the account value will be $100,000 at the year 2050. The realization date may be any date associated with the guarantee. For example, the realization date may be a date that is a predetermined amount of time after the guarantee is made (e.g., 1 year after the guarantee, 2 years after the guarantee, 3 years after the guarantee, 5 years after the guarantee, 10 years after the guarantee, 20 years after the guarantee, 30 years after the guarantee, or any other suitable amount of time after the guarantee), a particular date associated with the guarantee (e.g., the guarantee will be due on Jan. 1, 2040), a date associated with the target date fund (e.g., the realization date may be before, after, or the same as the target date of the target date fund, such as the realization date may be Jan. 1, 2060 when the 2060 target date fund has a target date of Jan. 1, 2060), or any other suitable date.

In order for system 10 to provide a guarantee associated with a target date fund, an investor may provide a guarantee request 80 to the issuer of the guarantee. For example, the investor may utilize user device 58 to provide guarantee request 80 to issuer device 50. Guarantee request 80 may represent a request for a guarantee associated with target date fund. Guarantee request 80 may include any information regarding a request for a guarantee. For example, guarantee request 80 may include data indicative of a target date fund that the investor is invested in (e.g., the name of the target date fund, an acronym associated with the target date fund, an identifier of the manager of the target date fund, the target date of the target date fund, the current portfolio of the target date fund, the risk assessment of the target date fund, etc.); data indicative of an account associated with the investments by the investor in the target date fund (e.g., account number, current account value, amount invested in the target date fund, etc.); a requested guarantee (e.g., the type of guarantee, the amount of the guarantee); a requested realization date (e.g., the date the guarantee is associated with); any other information associated with the request for a guarantee, or any combination of the preceding.

Furthermore, although guarantee request 80 may be sent at any time, the ability to receive a guarantee for a particular target date fund may be open and/or closed. For example, the ability to receive a guarantee from the issuer may be open when the investor can purchase the guarantee at any time prior to the realization date. In such an example, the investor may purchase a guarantee for a target date fund one hour before the realization date, one day before the realization date, twenty years before the realization date, or any other time before the realization date. On the other hand, the ability to purchase a guarantee on the target date fund may be closed. In such an example, the investor may only be able to receive a guarantee on the target date fund if the guarantee is purchased a predetermined amount of time before the realization date. For example, the issuer may only issue a guarantee on a target date fund if the investor purchases the guarantee five years before the realization date, ten years before the realization date, fifteen years before the realization date, or any other predetermined amount of time before the realization date. If the predetermined time has passed, the option for a guarantee may be closed and the investor may be unable to purchase a guarantee. On the other hand, the investor may still be able to purchase a guarantee if the investor is willing to pay an additional re-opening premium amount.

Following the receipt of guarantee request 80 by issuer device 50, issuer device 50 may communicate guarantee message 82 to calculation device 14. Guarantee message 82 may include any information for use and storage by calculation device 14 in association with the guarantee. For example, guarantee message 82 may include all or a portion of the information included in guarantee request 80. As another example, guarantee message 82 may include (or further include) any information for use by calculation device 14 to calculate one or more premium amounts associated with the issuer providing a guarantee for the target date fund (as is discussed below). In such an example, the calculated premium amount may be agreed to by the investor (and/or paid by the investor) in order for issuer to provide the guarantee to the investor. As a further example, guarantee message 82 may include (or further include) any information for use by the calculation device 14 to perform calculations, determinations, and/or communications associated with a guarantee, such as tracking (or otherwise checking) whether or not the guarantee is expected to be met by the account value of the investor's account at the realization date based on market performance of the target date fund. In such an example, guarantee message 82 may include information indicative of a guarantee activation date (e.g., the date when calculation device 14 may begin tracking whether or not the guarantee is expected to be met by the account value at the realization date).

Following a receipt of guarantee message 82 by calculation device 14, calculation device 14 may calculate one or more premium amounts associated with the issuer providing a guarantee for the target date fund. Calculation device 14 may calculate any suitable number of premium amounts. For example, calculation device 14 may calculate one premium amount for providing the requested amount of guarantee for the target date fund. As another example, calculation device 14 may calculate more than one premium amount for providing more than one guarantee for the target date fund, such as two premium amounts, three premium amounts, five premium amounts, ten premium amounts, or any other number of premium amounts. In such an example, in response to the investor requesting a particular amount of guarantee (e.g., −15% rate of return), calculation device 14 may calculate a premium amount for providing the −15% guarantee, and may further calculate premium amounts for providing different guarantees (e.g., −25%, −20%, −10%, −5%, etc.) and/or different options for guarantees, such as a number of resets available for the guarantee (discussed below) and/or the type of guarantee (e.g., a guarantee of the principal amount). As such, the investor may be provided with a range of guarantees that the investor may select from. Calculation device 14 may further calculate more than one premium amount even if the investor does not request a particular amount of guarantee, a particular type of guarantee, and/or one or more options for the guarantee.

Calculation device 14 may calculate a premium amount in any suitable manner. As an example, a premium amount may be calculated based on the amount (including the rate or return) of the guarantee (e.g., the lower the guarantee, the less expensive the premium amount may be), the amount of time before the realization date (e.g., the longer the amount of time, the less expensive the premium amount may be), the availability of one or more resets (e.g., the lower the amount of available resets, the less expensive the premium amount may be), the amount invested by the investor, the target date fund invested in by the investor (e.g., the more stable the target date fund, the less expensive the premium amount may be), any other suitable factor, or any combination of the preceding.

Following the calculation of one or more premium amounts, calculation device 14 may communicate premium amount message 84 for display. Premium amount message 84 may include any information regarding the calculated premium amounts and the guarantees associated with the premium amounts. For example, premium amount message 84 may include an indication of the premium amount for a guarantee of −15% with no resets, the premium amount for a guarantee of −15% with 1 reset, the premium amount for a guarantee of −20% with no resets, the premium amount for a guarantee of −20% with 1 reset, the premium amount for any other guarantee, or any combination of the preceding. As such, an employee of the issuer (or any other person, entity, etc.) may be able to communicate the premium amounts associated with the guarantee to the investor, and the investor can select one of the guarantees. Although premium amount message 84 is illustrated as being communicated to issuer device 50, premium amount message 84 may be communicated to the investor (e.g., user device 58).

Following the selection of one of the guarantees by the investor, calculation device 14 may receive selection message 86. Selection message 86 may include any information regarding the selection (or acceptance) of a guarantee by the investor. For example, selection message 86 may include an indication of the guarantee selected by the investor (e.g., a selection of a guarantee of −15% of the principal amount), an indication that the principal amount has been paid by the investor, or any other information. Following the reception of selection message 86, calculation device 14 may wait until a guarantee activation date for the selected guarantee occurs.

At a guarantee activation date, calculation device 14 may begin tracking (or otherwise checking) whether or not the guarantee is expected to be met by the account value of the investor's account at the realization date based on market performance of the target date fund. The guarantee activation date may be any predetermined date, such as an amount of time before the realization date (e.g., one day before the realization date, one month before the realization date, one year before the realization date, three years before the realization date, ten years before the realization date, etc.), a particular date (e.g., Jan. 1, 2040), a date associated with the target date of the target date fund (e.g., the predetermined date may be ten years before the target date, twenty years before the target date, etc.), or any other predetermined date.

In order to track (or otherwise check) whether or not the guarantee is expected to be met by the account value at the realization date, calculation device 14 may receive information message 88 from a data source 62. Information message 88 may include any information that may facilitate a determination regarding whether the guarantee is expected to be met at the realization date and/or whether the guarantee was actually met at the realization date. For example, information message 88 may include current data associated with the account value of the investments by the investor in the target date fund (e.g., the actual current account value, the number of shares currently owned by the investor, etc.), current and/or forecasted target date fund information (e.g., current and/or forecasted rates of return based on market performance, current and/or forecasted price per share, etc.), any other information associated with the target date fund, the account value of the investor, and/or the guarantee, or any combination of the preceding. Information message 88 may be received from any type of data source 62. As an example, information message 88 may be received from third parties, such as Moody's Investors Service, Barclays Investment Bank, Standard & Poor's, the manager of the target date fund, an investment firm the investor is investing in the target date fund with or that has access to the investor's account, any other third party, or any combination of the preceding.

Based on the information included in information message 88, calculation device 14 may compare the current account value of the investments by the investor in the target date fund to the guarantee. For example, if the current account value is $100,000 and the guarantee is $75,000, the $100,000 current value may be compared to the $75,000 guarantee value in order to determine that the account value is currently exceeding the guarantee by $25,000. Based on the comparison, calculation device 14 may determine whether the guarantee is expected to be met by the account value at the realization date. For example, calculation device 14 may utilize the comparison along with a forecasted rate of return of the target date fund in order to determine whether the guarantee is expected to be met by the account value by the realization date. In such an example, if the account value is $100,000, the guarantee is $75,000, the realization date is one year away, and the target date fund is forecasted to provide a rate of return of 2% for the year, it may be determined that the guarantee is expected to be met by the account value at the realization date. On the other hand, if the account value is $75,000, the guarantee is $100,000, the realization date is one year away, and the target date fund is forecasted to provide a rate of return of 0% for the next year, it may be determined that the guarantee is not expected to be met by the account value at the target date fund.

Following the determination, calculation device 14 may communicate expectation results message 90 to issuer device 50 for display. Expectation results message 90 may include any information regarding whether the guarantee is expected to be met by the account value at the realization date. For example, expectation results message 90 may include an indication of whether the guarantee is expected to be met by the account value at the realization date, the amount of the guarantee, the amount the account value is expected to be at the realization date, the difference (e.g., positive, negative, or no difference) between the guarantee and the amount the account value is expected to be at the realization date, any other information associated with the target date fund, the account value, and/or the guarantee, or any combination of the preceding. After expectation results message 90 is received by issuer device 50, all or a portion of the information in expectation results message 90 may be displayed at the issuer device 50. As such, an employee of the issuer (or any other person, entity, etc.) may be able to view and understand whether or not the guarantee is expected to be met at the realization date. As such, the issuer may be able to prepare for whether or not the issuer may have to pay out on the guarantee associated with the target date fund.

The tracking (or checking) associated with the guarantee may occur any number of times following the guarantee activation date. For example, the tracking of the guarantee may occur once, twice, three times, four times, ten times, or any other number of times. As another example, the tracking may occur periodically (e.g., hourly, daily, monthly, yearly, any other period of time, etc.). As a further example, the tracking may occur at the request of the issuer. When the tracking of the guarantee occurs more than once, calculation device 14 may receive information message 88 each time the tracking occurs, and may communicate expectation results message 90 each time the tracking occurs. Furthermore, although calculation device 14 has been described above as communicating expectation results message 90 each time tracking occurs for the guarantee, calculation device 14 may only communicate expectation results message 90 if it is determined that the guarantee is not expected to be met at the realization date. As such, issuer device 50 may only receive expectation results message 90 when the guarantee is not expected to be met.

The tracking associated with the guarantee may occur until the realization date occurs. At the realization date, calculation device 14 may determine whether the guarantee was actually met by the account value. For example, calculation device 14 may receive another information message 88. Based on this information message 88, calculation device 14 may determine whether the guarantee was met by the account value. As an example, calculation device 14 may compare the current account value to the guarantee. In such an example, if the current account value is $100,000 and the guarantee is $75,000, calculation device 14 may determine that the guarantee was met by the account value. On the other hand, if the current account value is $75,000 and the guarantee is $100,000, calculation device 14 may determine that the guarantee was not met by the account value. Following the determination, calculation device 14 may communicate actual results message 92 to issuer device 50 for display. Actual results message 92 may include any information regarding whether the guarantee was met. For example, actual results message 92 may include an indication of whether the guarantee was met by the account value at the realization date, the amount of the guarantee, the amount of the account value at the realization date, the difference (e.g., positive, negative, or no difference) between the guarantee and the account value, any other information associated with the target date fund, the account value, and/or the guarantee, or any combination of the preceding. After actual results message 92 is received by issuer device 50, all or a portion of the information in actual results message 92 may be displayed at the issuer device 50. As such, an employee of the issuer (or any other person, entity, etc.) may be able to view and understand whether the guarantee was met at the realization date. Therefore, the issuer may be able to provide a payout of the difference between the account value and the guarantee if the guarantee was not met.

Although calculation device 14 has been described above as communicating actual results message 92 whether or not the guarantee was met, calculation device 14 may only communicate actual results message 92 if it is determined that the guarantee was not met at the realization date. As such, issuer device 50 may only receive actual results message 92 when the guarantee was not met.

Payouts on the guarantee may be paid to the investor in any suitable manner. For example, a payout of the difference between the account value and the guarantee may be made in a single payment or in multiple payments. As an example of the multiple payments, the difference may be paid over any period of time (e.g., one year, two years, three years, ten years, etc.), any number of payments (e.g., two payments, three payments, four payments, etc.), or any combination of the preceding. Furthermore, payouts on the guarantee may be initiated by calculation device 14 and/or issuer device 50. As an example, actual results message 92 received from calculation device 14 may include an instruction to payout the difference between the account value and the guarantee to the investor. As another example, calculation device 14 may automatically cause the payout to be transferred directly to the investor. As is discussed above, the investor may represent any entity that may invest in a target date fund. When the investor is a individual person and the guarantee promised by the issuer is not met by the realization date, the individual person may receive the payout based on the guarantee. However, when the investor is a fund and the guarantee is not met, the fund may receive a payout on the guarantee. As such, one or more investors in the fund may each receive payouts based on the guarantee.

Although the guarantee associated with a target date fund has been described above as providing a particular guarantee (e.g., a negative guarantee of −20%) on a particular portion of an account value at a particular realization date, one or more of the factors of the guarantee may be reset. For example, as is discussed below, the portion of the account value that is guaranteed may be reset, the guarantee may be reset, and/or the realization date may be reset.

As a first example, the portion of the account value that is guaranteed may be reset. The portion of the account value that is guaranteed may be reset to be a larger portion, a smaller portion, or a different portion of the account value. As an example, as is discussed above, the guarantee may provide a guarantee of the principal amount. This guarantee, however, may be reset to provide a guarantee of the entire account value at the time of the reset (e.g., the principal amount may be reset to include the entire account value at the time of the reset, as opposed to just the deposits made by the investor). For example, the issuer may initially provide a guarantee that a principle amount of $75,000 is guaranteed to receive an annual rate of return of 2%. However, market performance of the target date fund may cause the initial $75,000 investment to be worth, for example, $100,000 after only a year. Due to this increase in the account value, the investor may desire to reset the principle amount to be the $100,000 account value (as opposed to the $75,000 value). As such, the principle amount may be reset to be $100,000 and the guarantee may now provide a guarantee that the principle amount of $100,000 will grow at a rate of return of 2%.

The reset of the portion of the account value that is guaranteed may be manual or automatic. For example, the reset of the portion of the account value that is guaranteed may occur when an investor requests a reset. The investor may be allowed to request a reset any number of times, may be allowed to request a reset the number of times specified in the guarantee contract between the investor and the issuer, or may be allowed to request a reset any number of times agreed to by the issuer. Reset of the portion of the account value that is guaranteed may also (or alternatively) be automatic. For example, if the portion of the account value that is guaranteed increases by a particular amount (e.g., 10%, for example), calculation device 14 may automatically reset the portion to be the new value. As another example, reset of the portion of the account value that is guaranteed may occur at predetermined times and/or on a periodic basis. In such an example, reset of the portion of the account value that is guaranteed may occur on a particular predetermined date (e.g., the third anniversary of the guarantee), every day, every month, every year, every 10 years, every 20 years, any other time period, or any combination of the preceding. Furthermore, although a reset may be scheduled to occur at certain predetermined times and/or on a periodic basis, a reset may not always occur at the predetermined times and/or on the periodic basis. For example, a reset may not occur if the reset would cause a decrease in the portion of the account value that is guaranteed.

The portion of the account value that is guaranteed may also be reset by the investor withdrawing a portion of the account value from the account. When such a reset occurs, the portion of the account that is guaranteed may be reset by the amount that was withdrawn. For example, if the investor's account has a guaranteed value of $100,000 and the investor withdraws $50,000 from the account prior to the realization date, the portion of the account that is guaranteed may be reset to be $50,000. In such an example, the investor may withdraw from the account without losing all of the guarantee provided by the issuer.

As a second example, the guarantee may be reset. For example, an initial guarantee by an issuer may guarantee that the principle amount of the account may receive a rate of return that is not less than −2%. As such, if the guaranteed portion of the account is $100,000, the guarantee may provide that the account value of the account is guaranteed to be at least $98,000 at the realization date. However, this guarantee may be reset. For example, the −2% rate of return may be reset to be another rate of return, such as, for example, −1%, 0%, 1%, 2%, 3%, or any other rate of return. As another example, if the account value is guaranteed to be $100,000 at a realization date, the guarantee may be reset to be, for example, $250,000 at the realization date. The reset of the guarantee may be manual or automatic. For example, the reset of the guarantee may occur when an investor requests a reset. The investor may be allowed to request a reset any number of times, may be allowed to request a reset the number of times specified in the guarantee contract between the investor and the issuer, or may be allowed to request a reset any number of times agreed to by the issuer. Additionally, the investor may be allowed to request a reset of the guarantee to any other guarantee, any other guarantee specified in the guarantee contract between the investor and the issuer, and/or any other guarantee agreed to by the issuer. Reset of the guarantee may also (or alternatively) be automatic.

As a third example, the realization date may be reset. For example, a guarantee may have an initial realization date of, for example, Jan. 1, 2060. This, realization date, however, may be reset to be any other date (or time). For example, the realization date may be reset from Jan. 1, 2060 to Jun. 30, 2060. As another example, the realization date may be rest from Jan. 1, 2060 to Jan. 1, 2070 or Jan. 1, 2050. As a further example, the realization date may be reset from Jan. 1, 2060 to any other time or date. The reset of the realization date may be manual or automatic. For example, the reset of the realization date may occur when an investor requests a reset. The investor may be allowed to request a reset any number of times, may be allowed to request a reset the number of times specified in the guarantee contract between the investor and the issuer, or may be allowed to request a reset the number of times agreed to by the issuer. Additionally, the investor may be allowed to request a reset of the realization date to any other realization date, any other realization date specified in the guarantee contract between the investor and the issuer, and/or any other realization date agreed to by the issuer. Reset of the realization date may also (or alternatively) be automatic.

Modifications, additions, or omissions may be made to the system 10 without departing from the scope of the disclosure. For example, although FIG. 1 has been described above as providing a guarantee associated with a target date fund, FIG. 1 may provide a guarantee associated with any other type of investment. As examples, FIG. 1 may provide a guarantee associated with one or more mutual funds, managed accounts, asset allocation programs, collected trusts, insurance separate accounts, variable investments trusts, any other investments, or any other combination of the preceding. Furthermore, one or more elements of the system 10 may be integrated or separated. For example, issuer device 50 and calculation device 14 may be the same device.

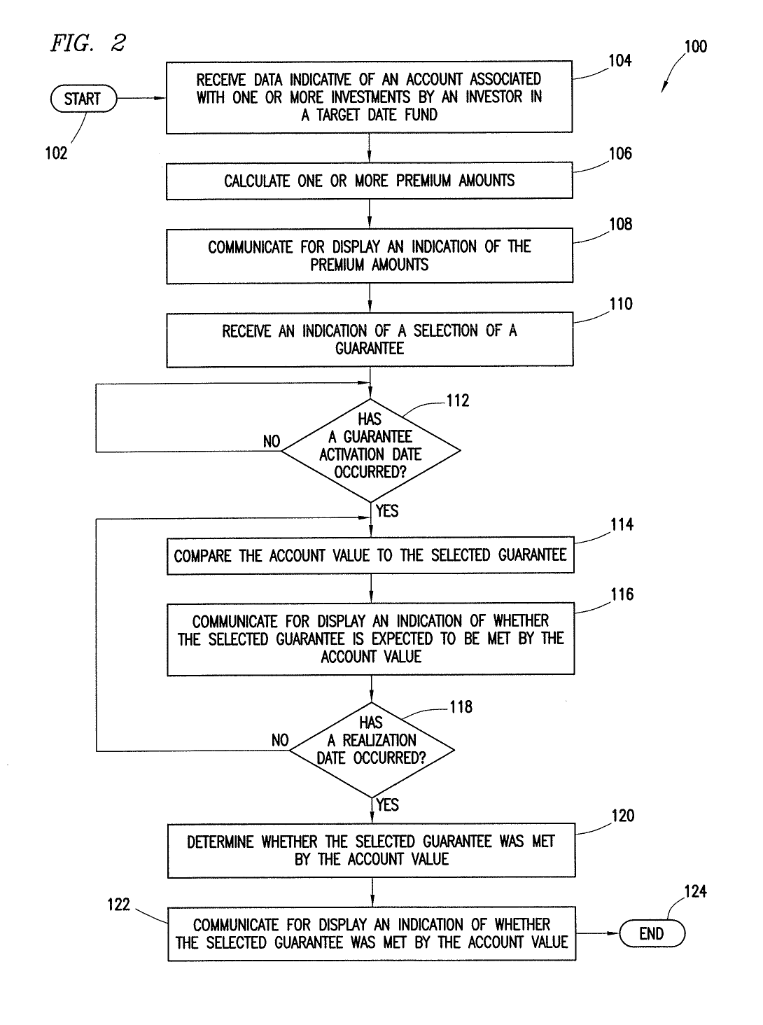

FIG. 2 illustrates an example method 100 for providing a guarantee associated with a target date fund (or any other investment). One or more steps of method 100 may be performed by calculation device 14 of FIG. 1.

The method begins at step 102. At step 104, data indicative of an account associated with one or more investments by an investor in a target date fund is received. The data indicative of an account may include any information associated with the account of an investor, any information that may identify an account of an investor, and/or any information that may be used to identify an account of an investor. For example, the data may include an identifier of the investor, an account number, a current account value, an identifier of a target date fund that the investor has invested in, an amount invested in the target date fund by the investor, any other information associated with the account of an investor, any other information that may identify an account of an investor, any other information that may be used to identify an account of an investor, or any combination of the preceding. The data indicative of an account may be received based on, for example, guarantee request 80, guarantee message 82, and/or information message 88 of FIG. 1. As such, the data indicative of an account may include one or more items of information included in guarantee request 80, guarantee message 82, and/or information message 88.

As is discussed above, the target date fund may represent an investment vehicle that may change the portfolio of assets in which it is invested over time based on time or date. The target date fund may include a target date and a portfolio of assets. The target date may be any time or date associated with the target date fund. Furthermore, the portfolio of assets in which the target date fund is invested in may include any suitable type of assets. Although the target date fund may include the portfolio of assets in which it is invested, the target date fund may change the portfolio of assets as the target date approaches.

At step 106, one or more premium amounts associated with the issuer providing a guarantee for the target date fund may be calculated. The premium amount may include an amount of premium due to be paid by the investor in order to receive a guarantee from the investor. Any suitable number of premium amounts may be calculated, such as one premium amount, two premium amounts, three premium amounts, five premium amounts, ten premium amounts, or any other number of premium amounts. Each of the calculated premium amounts may be associated with a different guarantee. Furthermore, each guarantee may have a different type of guarantee, a different amount of the guarantee, a different number of options for the guarantee, any other difference, or any combination of the preceding. For example, a first premium amount may be for a −15% guarantee of the principal amount and an option for two resets, a second premium amount may be for a −15% guarantee of the principal amount and an option for no resets, and a third premium amount may be for a −20% guarantee of the principal amount and an option for no resets.

The premium amounts may be calculated in any suitable manner. As an example, a premium amount may be calculated based on the amount of the guarantee (e.g., the lower the guarantee, the less expensive the premium amount may be), the amount of time before the realization date (e.g., the longer the amount of time, the less expensive the premium amount may be), the availability of one or more resets (e.g., the lower the amount of available resets, the less expensive the premium amount may be), the amount invested by the investor, the target date fund invested in by the investor (e.g., the more stable the target date fund, the less expensive the premium amount may be), any other suitable factor, or any combination of the preceding. Additionally, the premium amounts may be calculated using any information included in, for example, guarantee request 80, guarantee message 82, and/or information message 88 of FIG. 1.

At step 108, an indication of the one or more premium amounts may be communicated for display. The indication may include any information regarding each calculated premium amount and the guarantee associated with the calculated premium amount. For example, the indication may include a premium amount for a guarantee of −15% with no resets, a premium amount for a guarantee of −15% with 1 reset, a premium amount for a guarantee of −20% with no resets, a premium amount for a guarantee of −20% with 1 reset, a premium amount for any other guarantee, or any combination of the preceding. The indication may be communicated to issuer device 50 as premium amount message 84 of FIG. 1. As such, an employee of the issuer (or any other person, entity, etc.) may be able to communicate the premium amounts associated with the guarantee to the investor, and the investor can select one of the guarantees. Furthermore, although the indication is described as being communicated to issuer device 50, the indication may be communicated to the investor (e.g., user device 58).

At step 110, an indication of a selection of a guarantee is received. The indication may include any information regarding the selection (or acceptance) of a guarantee by the investor. For example, the indication may include information regarding the guarantee selected by the investor (e.g., a selection of a guarantee of −15% of the principal amount), an indication that the principal amount has been paid by the investor, or any other information. The selected guarantee may be any guarantee associated with an investor's investment in any target date fund. The selected guarantee may be a positive guarantee, a negative guarantee, or any other guarantee. The selected guarantee may provide a guarantee on all or a portion of the account value of the investor in the target date fund. Furthermore, the selected guarantee may provide that an account value of the investor in the target date fund will meet (i.e., be equal to or exceed) the selected guarantee at the realization date of the guarantee. As an example, the selected guarantee may be a negative guarantee that provides a guarantee to the investor that, at a realization date, an account value of the account will be at least equal to an amount less than a principal amount associated with the one or more investments regardless of market performance of the target date fund. The indication received at step 110 may be communicated to calculation device 14 as selection message 86 of FIG. 1.

At step 112, it is determined whether a guarantee activation date for the selected guarantee has occurred. The guarantee activation date may be a date when tracking (or otherwise checking) of whether or not the guarantee is expected to be met by the account value at the realization date may begin occurring. The guarantee activation date may be any predetermined date, such as an amount of time before the realization date, a particular date, a date associated with the target date of the target date fund, or any other predetermined date. If the guarantee activation date has not occurred, the method may move back to step 112 where it is determined whether a guarantee activation date has occurred. This may continue until the guarantee activation date has occurred. On the other hand, if the guarantee activation date has occurred, the method may move to step 114.

At step 114, the account value is compared to the selected guarantee. For example, if the current account value of an investors' account is $100,000 and the guarantee is $75,000, the $100,000 current value may be compared to the $75,000 guarantee value in order to determine that the account value is currently exceeding the guarantee by $25,000. Based on the comparison, it may be determined whether the guarantee is expected to be met by the account value at the realization date. For example, if the account value is $100,000, the guarantee is $75,000, the realization date is one year away, and the target date fund is forecasted to provide a rate of return of 2% for the year, it may be determined that the guarantee is expected to be met by the account value at the realization date. On the other hand, if the account value is $75,000, the guarantee is $100,000, the realization date is one year away and the target date fund is forecasted to provide a rate of return of 0% for the next year, it may be determined that the guarantee is not expected to be met by the account value at the target date. The comparison of the account value to the guarantee may occur based on any received information. As an example, the information used to conduct the comparison may be included in, for example, information message 88 of FIG. 1. Furthermore, the information used in the comparison may include any information that may facilitate a determination regarding whether the guarantee is expected to be met at the realization date.

At step 116, an indication of whether the selected guarantee is expected to be met by the account value is communicated for display. The indication may include any information regarding whether the guarantee is expected to be met by the account value at the realization date. For example, the indication may include an indication of whether the guarantee is expected to be met by the account value at the realization date, the amount of the guarantee, the amount the account value is expected to be at the realization date, the difference between the guarantee and the amount the account value is expected to be at the realization date, any other information associated with the target date fund, the account value, and/or the guarantee, or any combination of the preceding. The indication may be communicated to issuer device 50 as expectation results message 90 of FIG. 1. As such, the issuer may be able to prepare for whether or not the issuer may have to pay out on the guarantee associated with the target date fund.

At step 118, it is determined whether a realization date has occurred. If a realization date has not occurred, the method may move back to steps 114 and 116, thereby causing additional steps of tracking (or checking) whether or not the guarantee is expected to be met by the account value at the realization date. The tracking (or checking) may occur any number of times. Furthermore, the tracking may occur periodically and/or at the request of the issuer. On the other hand, if a realization date has occurred, the method may move to step 120.

At step 120, it is determined whether the selected guarantee was met by the account value. For example, the current account value of the investor's account may be determined, and the current account value may be compared to the guarantee in order to determine whether the guarantee was met by the account value. In such an example, if the current account value is $100,000 and the guarantee is $75,000 it may be determined that the guarantee was met by the account value. On the other hand, if the current account value is $75,000 and the guarantee is $100,000, it may be determined that the guarantee was not met by the account value. The determination regarding whether the guarantee was met by the account value may occur based on any received information. As an example, the information used to conduct the determination may be included in, for example, information message 88 of FIG. 1. Furthermore, the information used in the determination may include any information that may facilitate a determination regarding whether the guarantee was met by the account value

At step 122, an indication of whether the selected guarantee was met by the account value is communicated for display. The indication may include any information regarding whether the guarantee was met. For example, the indication may include an indication of whether the guarantee was met by the account value at the realization date, the amount of the guarantee, the amount of the account value at the realization date, the difference between the guarantee and the account value, any other information associated with the target date fund, the account value, and/or the guarantee, or any combination of the preceding. The indication may be communicated to issuer device 50 as actual results message 92 of FIG. 1. As such, an employee of the issuer (or any other person, entity, etc.) may be able to view and understand whether the guarantee was met at the realization date. Therefore, the issuer may be able to provide a payout of the difference between the account value and the guarantee if the guarantee was not met. Once the indication is communicated for display, the method may move to step 124, where the method ends.

Modifications, additions, or omissions may be made to method 100. As an example, although method 100 of FIG. 2 has been described above as providing a guarantee associated with a target date fund, method 100 of FIG. 2 may provide a guarantee associated with any other type of investment. As examples, method 100 of FIG. 2 may provide a guarantee associated with one or more mutual funds, managed accounts, asset allocation programs, collected trusts, insurance separate accounts, variable investments trusts, any other investments, or any other combination of the preceding. Furthermore, the steps of method 100 of FIG. 2 may be performed for any number of investments and/or any number of investors. For example, the steps of method 100 of FIG. 2 may be performed for more than one investment and/or more than one investor in parallel, such as two investments and/or investors, 100 investments and/or investors, 1,000 investments and/or investors; 1 million investments and/or investors, 100 million investments and/or investors, or any other number of investments and/or investors. As such, calculation device 14 may perform calculations and/or determinations for any number of investments and/or investors in parallel.

As another example, method 100 of FIG. 2 may further include steps associated with one or more resets of the portion of the account value that is guaranteed, the guarantee, and/or the realization date. As an example, the amount of the account value that is guaranteed (e.g., the principal amount) may be reset manually or automatically, the guarantee may be reset manually or automatically, and/or the realization date may be reset manually or automatically. Furthermore, one or more steps in method 100 of FIG. 2 may be performed in parallel or in any suitable order. Additionally, any other systems and/or components (such as one or more systems and/or components of FIG. 1) may be utilized to perform one or more steps in method 100 of FIG. 2.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a memory;
one or more processors communicatively coupled to the memory and operable to:
receive data indicative of an account associated with one or more investments by an investor in a target date fund, the target date fund comprising a target date and a portfolio of assets, the target date fund configured to change the portfolio of assets as the target date approaches;
calculate a plurality of premium amounts for a plurality of negative guarantees associated with the account, each of the plurality of premium amounts being associated with a different one of the plurality of negative guarantees;
communicate for display an indication of the plurality of premium amounts and the associated plurality of negative guarantees;
receive an indication of a selection of one of the associated plurality of negative guarantees, the selected negative guarantee providing a guarantee to the investor that, at a realization date, an account value of the account will be at least equal to an amount less than a principal amount associated with the one or more investments regardless of market performance of the target date fund;
beginning at a predetermined date before the realization date, periodically:
compare the account value to the selected negative guarantee; and
based on the comparison, communicate for display an indication of whether the selected negative guarantee is expected to be met by the account value based on the market performance of the target date fund; and
at the realization date:
determine whether the selected negative guarantee was met by the account value; and
following the determination, communicate for display an indication of whether the selected negative guarantee was met by the account value.

2. The system of claim 1, wherein the amount less than the principal amount is an amount greater than or equal to 75% of the principal amount and less than 99.99% of the principal amount.

3. The system of claim 1, wherein the amount less than the principal amount is an amount greater than 50% of the principal amount and less than 95% of the principal amount.

4. The system of claim 1, wherein the one or more processors are further operable to:
receive an indication that the investor has requested a reset of the principal amount; and
following the reception of the indication that the investor has requested the reset of the principal amount, reset the principal amount to be equal to the account value at the date of the reset.

5. The system of claim 1, wherein the one or more processors are further operable to:
receive an indication that the investor has requested a reset of the selected negative guarantee; and
following the reception of the indication that the investor has requested the reset of the selected negative guarantee, reset the selected negative guarantee to provide a guarantee to the investor that the account value at the realization date will be at least equal to a second amount regardless of the market performance of the target date fund.

6. The system of claim 1, wherein the one or more processors are further operable to:
receive an indication that the investor has withdrawn at least a portion of the account value prior to the realization date;
following the reception of the indication that the investor has withdrawn at least the portion of the account value prior to the realization date, calculate a new principal amount associated with the one or more investments; and
reset the principal amount associated with the one or more investments to be equal to the new principal amount.

7. The system of claim 1, wherein each of the plurality of premium amounts is calculated based on an associated amount of the negative guarantee, an amount of time remaining before an associated realization date, and whether the investor will have the ability to reset the negative guarantee associated with the premium amount or the principal amount.

8. A non-transitory computer readable medium comprising logic, the logic, when executed by a processor, operable to:
receive data indicative of an account associated with one or more investments by an investor in a target date fund, the target date fund comprising a target date and a portfolio of assets, the target date fund configured to change the portfolio of assets as the target date approaches;
calculate a plurality of premium amounts for a plurality of negative guarantees associated with the account, each of the plurality of premium amounts being associated with a different one of the plurality of negative guarantees;
communicate for display an indication of the plurality of premium amounts and the associated plurality of negative guarantees;
receive an indication of a selection of one of the associated plurality of negative guarantees, the selected negative guarantee providing a guarantee to the investor that, at a realization date, an account value of the account will be at least equal to an amount less than a principal amount associated with the one or more investments regardless of market performance of the target date fund;
beginning at a predetermined date before the realization date, periodically:
compare the account value to the selected negative guarantee; and
based on the comparison, communicate for display an indication of whether the selected negative guarantee is expected to be met by the account value based on the market performance of the target date fund; and
at the realization date:
determine whether the selected negative guarantee was met by the account value; and
following the determination, communicate for display an indication of whether the selected negative guarantee was met by the account value.

9. The computer readable medium of claim 8, wherein the amount less than the principal amount is an amount greater than or equal to 75% of the principal amount and less than 99.99% of the principal amount.

10. The computer readable medium of claim 8, wherein the amount less than the principal amount is an amount greater than 50% of the principal amount and less than 95% of the principal amount.

11. The computer readable medium of claim 8, wherein the logic, when executed by the processor, is further operable to:
receive an indication that the investor has requested a reset of the principal amount; and
following the reception of the indication that the investor has requested the reset of the principal amount, reset the principal amount to be equal to the account value at the date of the reset.

12. The computer readable medium of claim 8, wherein the logic, when executed by the processor, is further operable to:
receive an indication that the investor has requested a reset of the selected negative guarantee; and
following the reception of the indication that the investor has requested the reset of the selected negative guarantee, reset the selected negative guarantee to provide a guarantee to the investor that the account value at the realization date will be at least equal to a second amount regardless of the market performance of the target date fund.

13. The computer readable medium of claim 8, wherein the logic, when executed by the processor, is further operable to:
receive an indication that the investor has withdrawn at least a portion of the account value prior to the realization date;
following the reception of the indication that the investor has withdrawn at least the portion of the account value prior to the realization date, calculate a new principal amount associated with the one or more investments; and
reset the principal amount associated with the one or more investments to be equal to the new principal amount.

14. A method, comprising:
receiving, by one or more processors, data indicative of an account associated with one or more investments by an investor in a target date fund, the target date fund comprising a target date and a portfolio of assets, the target date fund configured to change the portfolio of assets as the target date approaches;
calculating a plurality of premium amounts for a plurality of negative guarantees associated with the account, each of the plurality of premium amounts being associated with a different one of the plurality of negative guarantees;
communicating for display an indication of the plurality of premium amounts and the associated plurality of negative guarantees;
receiving an indication of a selection of one of the associated plurality of negative guarantees, the selected negative guarantee providing a guarantee to the investor that, at a realization date, an account value of the account will be at least equal to an amount less than a principal amount associated with the one or more investments regardless of market performance of the target date fund;
beginning at a predetermined date before the realization date, periodically:
comparing, by the one or more processors, the account value to the selected negative guarantee; and
based on the comparison, communicating, by the one or more processors, for display an indication of whether the selected negative guarantee is expected to be met by the account value based on the market performance of the target date fund; and
at the realization date:
determining, by the one or more processors, whether the selected negative guarantee was met by the account value; and
following the determination, communicating, by the one or more processors, for display an indication of whether the selected negative guarantee was met by the account value.

15. The method of claim 14, wherein the amount less than the principal amount is an amount greater than or equal to 75% of the principal amount and less than 99.99% of the principal amount.

16. The method of claim 14, wherein the amount less than the principal amount is an amount greater than 50% of the principal amount and less than 95% of the principal amount.

17. The method of claim 14, further comprising:
receiving, by the one or more processors, an indication that the investor has requested a reset of the principal amount; and
following the reception of the indication that the investor has requested the reset of the principal amount, resetting, by the one or more processors, the principal amount to be equal to the account value at the date of the reset.

18. The method of claim 14, further comprising:
receiving, by the one or more processors, an indication that the investor has requested a reset of the selected negative guarantee; and
following the reception of the indication that the investor has requested the reset of the selected negative guarantee, resetting, by the one or more processors, the selected negative guarantee to provide a guarantee to the investor that the account value at the realization date will be at least equal to a second amount regardless of the market performance of the target date fund.

19. The method of claim 14, further comprising:
receiving, by the one or more processors, an indication that the investor has withdrawn at least a portion of the account value prior to the realization date;
following the reception of the indication that the investor has withdrawn at least the portion of the account value prior to the realization date, calculating, by the one or more processors, a new principal amount associated with the one or more investments; and
resetting, by the one or more processors, the principal amount associated with the one or more investments to be equal to the new principal amount.

20. The method of claim 14, wherein each of the plurality of premium amounts is calculated based on an associated amount of the negative guarantee, an amount of time remaining before an associated realization date, and whether the investor will have the ability to reset the negative guarantee associated with the premium amount or the principal amount.
